(19) United States
(12) Patent Application Publication
(10) Pub. No.: US 2025/0010487 A1
(43) Pub. Date: Jan. 9, 2025

(54) SHOCK-ABSORBING TRAY MODULE AND SERVING ROBOT EQUIPPED WITH SAME

(71) Applicant: LG ELECTRONICS INC., Seoul (KR)

(72) Inventor: Haklim LEE, Seoul (KR)

(73) Assignee: LG ELECTRONICS INC., Seoul (KR)

(21) Appl. No.: 18/711,731

(22) PCT Filed: Dec. 20, 2021
(86) PCT No.: PCT/KR2021/019394

§ 371 Date: May 20, 2024

(51) Int. Cl. B25J 11/00; A47F 10/06; B25J 19/00; F16F 15/02; G06Q 50/12

(52) U.S. Cl. CPC B25J 11/008; A47F 10/06; B25J 19/0091; F16F 15/022; G06Q 50/12

(57) ABSTRACT

A shock-absorbing tray module includes a tray housing, a tray plate located on a top surface of the tray housing, a bottom casing located under the tray plate and mounted in the tray housing, a guide plate coupled to the bottom casing to be movable within a predetermined range, a damper located between the tray plate and the guide plate and whose length varies depending on a movement of the tray plate, and a return spring located between the tray plate and the bottom casing.

### CROSS REFERENCE TO RELATED APPLICATIONS

This application is the National Phase of PCT International Application No. PCT/KR2021/019394, filed on Dec. 20, 2021, the contents of which is hereby expressly incorporated by reference into the present application.

### TECHNICAL FIELD

The present disclosure relates to a shock-absorbing tray module and a serving robot equipped with the same.

### BACKGROUND

To take charge of a portion of factory automation, robots have been developed for industrial use. Recently, fields of application of robots have been further expanding, and not only a medical robot and an aerospace robot, but also a robot that may be used in a daily life are being developed.

Such robots for the daily life is being developed to provide a specific service (e.g., shopping, serving, conversation, cleaning, and the like) in response to a user command. Unlike the industrial robot that performs repetitive tasks by being fixed at a specific location or a robot that performs a specific specialized function at a high cost, such as the medical or aerospace robots, travel and communication functions are important for the robot for daily life and the robot for daily life is difficult to be distributed when a manufacturing cost thereof is too high.

In particular, because the robot does not walk on two feet like humans but moves using wheels, the robot must be able to move over a bump on the floor or avoid an obstacle, must be able to minimize impact without falling when moving over the bump on the floor, and must be able to make quick decisions using multiple sensors to avoid the obstacle.

One that has been actively developed recently as an example of such a robot is a serving robot that may transport a bowl containing liquid food such as noodle or soup. The bowl containing the food may be put on a tray equipped in the robot and the robot may transport the food to a customer or a service provider.

Korean Patent Application Publication No. 10-2020-0085658 A (published on Jul. 15, 2020) discloses a robot including a tray, a main body having a tray space defined therein in which the tray is accommodated and a tray entrance, a tray moving mechanism that moves at least a portion of the tray to the outside of the tray entrance or moves an entirety of the tray into the tray space, a door for opening and closing the tray entrance, and a door driving mechanism connected to the door to open and close the door.

### SUMMARY

### Technical Problem

A robot according to the prior art may accelerate, decelerate, and turn sharply while traveling, and when a bowl containing liquid food is put on a tray, the liquid food may overflow.

The present disclosure is to provide a tray that may minimize overflow of liquid food in a bowl while transporting the bowl containing the liquid food, and a robot including the tray.

### Technical Solutions

Provided is a shock-absorbing tray module including a tray housing, a tray plate located on a top surface of the tray housing, a bottom casing located under the tray plate and mounted in the tray housing, a guide plate coupled to the bottom casing to be movable within a predetermined range, a damper located between the tray plate and the guide plate and whose length varies depending on a movement of the tray plate, and a return spring located between the tray plate and the bottom casing.

The damper may include a plurality of dampers arranged to be spaced apart from each other at an equal spacing along a circumference of the tray plate.

The return spring may include a plurality of return springs arranged to be spaced apart from each other at an equal spacing along the circumference of the tray plate, wherein each return spring is located between a pair of dampers.

The damper may be coupled to the guide plate and the tray plate in a hinge manner.

A size of the guide plate may be smaller than a size of the tray plate, and the damper may be inclined from the guide plate and extend upwards.

The damper may form an angle equal to or greater than 40° and equal to or smaller than 45° with the guide plate.

The return spring may be disposed in a vertical direction, and a vertical buffering force of the return spring may be smaller than a buffering force of the damper.

The shock-absorbing tray module may further include a rolling pin protruding from the bottom casing and being in contact with the guide plate.

The bottom casing may include an opening defined therein, and the guide plate may include an upper guide plate located on the bottom casing, a lower guide plate located beneath the bottom casing, and a fastening screw located in the opening of the bottom casing and fastening the upper guide plate with the lower guide plate.

The opening of the bottom casing may be in a circular shape with a diameter greater than a diameter of the fastening screw.

The rolling pin may include a first guide pin facing the upper guide plate and a second guide pin facing the lower guide plate.

The first guide pin and the second guide pin may be arranged alternately along a circumference of the opening of the bottom casing.

The bottom casing may further include a stop step at a periphery thereof.

The damper may include an air cylinder.

According to another aspect of the present disclosure, provided is a serving robot including a driver that provides a travel function, a body located on the driver, and a shock-absorbing tray module located in the body, wherein the shock-absorbing tray module includes a tray housing, a tray plate located on a top surface of the tray housing, a bottom casing located under the tray plate and mounted in the tray housing, a guide plate coupled to the bottom casing to be movable within a predetermined range, a damper located between the tray plate and the guide plate and whose length varies depending on a movement of the tray plate, and a return spring located between the tray plate and the bottom casing.

A size of the guide plate may be smaller than a size of the tray plate, and the damper may form an angle equal to or greater than 40° and equal to or smaller than 45° with the guide plate and extend upwards.

The return spring may be disposed in a vertical direction, and a vertical buffering force of the return spring may be smaller than a buffering force of the damper.

The serving robot may further include a rolling pin protruding from the bottom casing and being in contact with the guide plate.

The bottom casing may include an opening defined therein, and the guide plate may include an upper guide plate located on the bottom casing, a lower guide plate located beneath the bottom casing, and a fastening screw located in the opening of the bottom casing and fastening the upper guide plate with the lower guide plate.

The shock-absorbing tray module may be located at an upper portion of the body, and the serving robot may include at least one of a general tray and a collection basket located under the shock-absorbing tray module.

### Advantageous Effects

According to the embodiment of the present disclosure, the guide plate may move on the bottom casing, and the plurality of dampers may absorb the shock by reducing the instantaneous acceleration of the serving robot, thereby minimizing the overflow of the liquid food in the bowl.

Additionally, the tray is able to be easily replaced, and the shock-absorbing tray module itself is not the electronic product, so that there is no risk of breakdown even with the inflow of water.

Because of the damper disposed at an angle, the forces in the vertical and lateral directions may be buffered, thereby minimizing the shaking resulted from the acceleration in addition to the shaking resulted from the bump.

Additionally, the shock-absorbing tray module is replaceable in the serving robot 1, making the maintenance easy.

Effects obtainable from the present disclosure are not limited by the above mentioned effects, and other unmentioned effects can be clearly understood from the above description by those having ordinary skill in the technical field to which the present disclosure pertains.

### BRIEF DESCRIPTION OF THE DRAWINGS

FIG. 1 is a perspective view showing a serving robot according to an embodiment of the present disclosure.

FIG. 2 is a drawing showing a state in which a housing of a driver of a serving robot according to an embodiment of the present disclosure is removed.

FIG. 3 is a diagram illustrating shocks that occur during traveling of a serving robot according to an embodiment of the present disclosure.

FIG. 4 shows a perspective view and a cross-sectional view of a shock-absorbing tray module according to an embodiment of the present disclosure.

FIG. 5 shows a top perspective view and a bottom perspective view of a shock-absorbing tray module according to an embodiment of the present disclosure.

FIG. 6 is a cross-sectional perspective view showing a state in which a housing of a shock-absorbing tray module according to an embodiment of the present disclosure is removed.

FIG. 7 is an exploded perspective view for illustrating coupling of a bottom casing and a guide plate of a shock-absorbing tray module according to an embodiment of the present disclosure.

FIG. 8 is a cross-sectional view showing a rolling pin of a shock-absorbing tray module according to an embodiment of the present disclosure.

FIG. 9 shows a plan view and a side view showing a damper and a return spring of a shock-absorbing tray module according to an embodiment of the present disclosure.

FIG. 10 is a partial side view to illustrate an arrangement of a damper of a shock-absorbing tray module according to an embodiment of the present disclosure.

FIG. 11 is a diagram to illustrate an operation of a return spring of a shock-absorbing tray module according to an embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated.

In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A robot is a machine device capable of automatically performing a certain task or operation. The robot may be controlled by an external control device or may be embedded in the control device. The robot can perform tasks that are difficult for humans to perform, such as repeatedly processing only a preset operation, lifting a heavy object, performing precise tasks or a hard task in extreme environments.

In order to perform such tasks, the robot includes a driver such as an actuator or a motor, so that the robot can perform various physical operations, such as moving a robot joint.

Industrial robots or medical robots having a specialized appearance for specific tasks due to problems such as high manufacturing costs and dexterity of robot manipulation were the first to be developed. Whereas industrial and medical robots are configured to repeatedly perform the same operation in a designated place, mobile robots have recently been developed and introduced to the market.

Robots for use in the aerospace industry can perform exploration tasks or the like on distant planets that are difficult for humans to directly go to, and such robots have a driving function.

In order to perform the driving function, the robot has a driver, wheel(s), a frame, a brake, a caster, a motor, etc. In order for the robot to recognize the presence or absence of surrounding obstacles and move while avoiding the surrounding obstacles, an evolved robot equipped with artificial intelligence has recently been developed.

Artificial intelligence refers to a technical field for researching artificial intelligence or a methodology for implementing the artificial intelligence. Machine learning refers to a technical field for defining various problems handled in the artificial intelligence field and for researching methodologies required for addressing such problems. Machine learning is also defined as an algorithm that improves performance of a certain task through continuous experience.

An artificial neural network (ANN) is a model used in machine learning, and may refer to an overall model having problem solving ability, which is composed of artificial neurons (nodes) that form a network by a combination of synapses. The artificial neural network (ANN) may be defined by a connection pattern between neurons of different layers, a learning process of updating model parameters, and an activation function of generating an output value.

The artificial neural network (ANN) may include an input layer and an output layer, and may optionally include one or more hidden layers. Each layer includes one or more neurons, and the artificial neural network (ANN) may include a synapse that interconnects neurons and other neurons.

In the artificial neural network (ANN), each neuron may output a function value of an activation function with respect to input signals received through synapses, weights, and deflection.

A model parameter may refer to a parameter determined through learning, and may include the weight for synapse connection and the deflection of neurons. In addition, the hyperparameter refers to a parameter that should be set before learning in a machine learning algorithm, and includes a learning rate, the number of repetitions, a mini-batch size, an initialization function, and the like.

The purpose of training the artificial neural network (ANN) can be seen as determining model parameters that minimize a loss function according to the purpose of the robot or the field of use of the robot.

The loss function can be used as an index for determining an optimal model parameter in a learning process of the artificial neural network (ANN).

Machine learning can be classified into supervised learning, unsupervised learning, and reinforcement learning according to learning methods.

Supervised learning refers to a method for training the artificial neural network (ANN) in a state where a label for learned data is given. Here, the label may refer to a correct answer (or a resultant value) that should be inferred by the artificial neural network (ANN) when the learned data is input to the artificial neural network (ANN). Unsupervised learning may refer to a method for training the artificial neural network (ANN) in a state where a label for learned data is not given. Reinforcement learning may refer to a learning method in which an agent defined in the certain environment learns to select an action or sequence of actions that can maximize cumulative compensation in each state.

Among artificial neural networks, machine learning implemented as a deep neural network (DNN) including a plurality of hidden layers is also referred to as deep learning, and deep learning is a part of machine learning. Hereinafter, machine learning is used in a sense including deep learning.

Artificial intelligence (AI) technology is applied to the robot, so that the robot can be implemented as a guide robot, a transportation robot, a cleaning robot, a wearable robot, an entertainment robot, a pet robot, and an unmanned aerial robot, etc.

The robot may include a robot control module for controlling operation thereof, and the robot control module may refer to a software module or a chip implemented in hardware.

By means of sensor information obtained from various types of sensors, the robot may acquire state information of the robot, may detect (recognize) the surrounding environment and the object, may generate map data, may determine a travel route and a travel plan, may determine a response to user interaction, or may determine a necessary operation.

The robot may perform the above-described operations using a learning model composed of at least one artificial neural network (ANN). For example, the robot may recognize the surrounding environment and object using a learning model, and may determine a necessary operation using the recognized surrounding environment information or object information. Here, the learning model may be directly learned from the robot or learned from an external device such as an AI server.

In this case, whereas the robot can perform a necessary operation by directly generating a result using the learning model, the robot may also perform an operation by transmitting sensor information to an external device such as an AI server and receiving the resultant information generated thereby.

The robot can perform autonomous driving through artificial intelligence. Autonomous driving refers to a technique in which a movable object such as a robot can autonomously determine an optimal path by itself and can move while avoiding collision with an obstacle. The autonomous driving technique currently being applied may include a technique in which the movable object (e.g., a robot) can travel while maintaining a current driving lane, a technique in which the movable object can travel while automatically adjusting a driving speed such as adaptive cruise control, a technique in which the movable object can automatically travel along a predetermined route, and a driving technique in which, after a destination is decided, a route to the destination is automatically set.

In order to perform autonomous driving, the movable object such as the robot may include a large number of sensors to recognize data of the surrounding situation. For example, the sensors may include a proximity sensor, an illumination sensor, an acceleration sensor, a magnetic sensor, a gyro sensor, an inertial sensor, an RGB sensor, an infrared (IR) sensor, a fingerprint recognition sensor, an ultrasonic sensor, an optical sensor, a microphone, a lidar, a radar, and the like.

The robot can perform autonomous driving not only based on information collected by sensors, but also based on image information collected by an RGBC camera and an infrared (IR) camera and sound information collected through a microphone. In addition, the robot can travel based on information received through a user input unit. Map data, location information, and information about peripheral situations can be collected through a wireless communication unit. The collected information is requisite for autonomous driving.

Map data may include object identification information for various objects disposed in a space where the robot moves. For example, the map data may include object identification information for fixed objects such as a wall and a door, and other object identification information for movable objects such as a flowerpot and a desk. In addition, the object identification information may include a name, a type, a distance, a location, etc.

Therefore, the robot may essentially include sensors, various input units, a wireless communication unit, and the like to collect data that can be learned by artificial intelligence, and can perform optimal operations by synthesizing various types of information. The learning processor for performing artificial intelligence can perform learning by being mounted in a controller embedded in the robot, can transmit the collected information to a server, can perform learning through the server, and can retransmit the learned result to the robot, so that the robot can perform autonomous driving based on the learned result.

A robot equipped with artificial intelligence can collect the surrounding information even in a new place to implement the entire map, and a large amount of information about a place of the major activity zone can be accumulated, so that the robot can perform more accurate autonomous driving.

The robot may include a touchscreen or a button to receive a user input, and may receive a command by recognizing a user's voice. In order to convert a voice input signal into a character string, the processor may obtain information about the intention corresponding to the user input using at least one of a speech to text (STT) engine for converting a voice input into a character string and a natural language processing (NLP) engine for obtaining information about the intention of natural language.

In this case, at least one of the STT engine and the NLP engine may include an artificial neural network (ANN) trained by a machine learning algorithm. In addition, at least one of the STT engine and the NLP engine may be trained by the learning processor, may be trained by the learning processor of the AI server, or may be trained by distributed processing of the trained results.

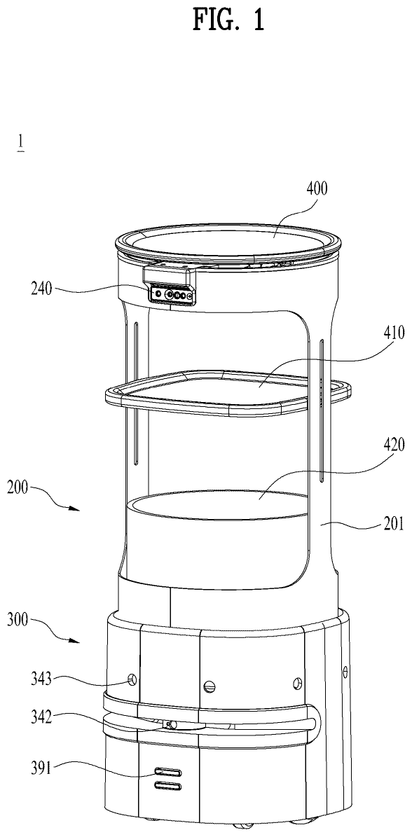

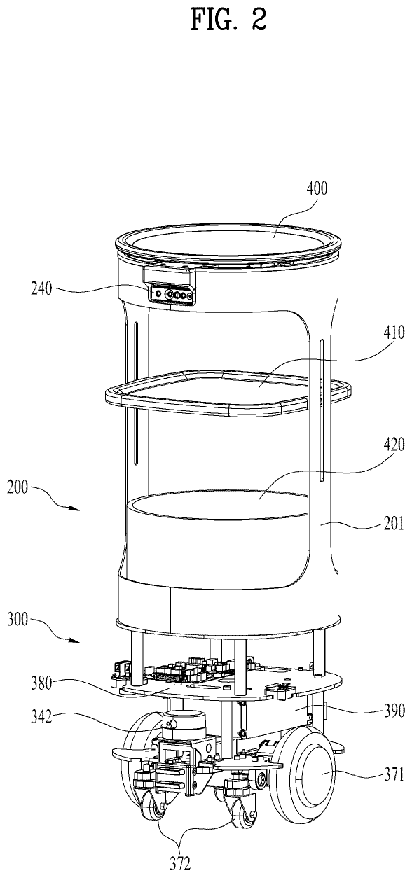

FIG. 1 is a perspective view showing a serving robot 1 according to an embodiment of the present disclosure, and FIG. 2 is a drawing showing a state in which a housing 407 of a driver of the serving robot 1 according to an embodiment of the present disclosure is removed.

The serving robot 1 in the present disclosure may include a driver 300 that includes wheels for traveling at a lower portion and trays 400, 410, and 420 on which food or the like may be placed at an upper portion. The driver 300, as a travel means that moves the serving robot, may include main wheels 371 and casters 372 to change a direction.

A battery 390 that provides power to operate the travel means may also be included in the driver 300, and a charging terminal 391 for charging the battery 390 may also be included outside the driver. A control box 380 that controls the serving robot 1 may be located above the battery 390, and a lidar 342, a camera 240, a proximity sensor 343, and the like may be included for the traveling.

There may be a plurality of trays 400, 410, and 420 located above the driver as shown in FIG. 1, and the trays 400, 410, and 420 may be fastened and fixed to a tray frame 201 and locations thereof may be adjusted on the tray frame 201.

A collection basket 420 having a side wall of a predetermined height may be included below the plurality of trays 400 and 410 to collect used bowls.

The collection basket 420 may be easily removed because it is easily contaminated and for easily transferring the bowls to a sink or a dishwasher, and may include a handle.

Food bowls to be delivered to a customer may be placed on the trays 400 and 410. When the food in the bowl is solid, there is a low risk of spilling, but when the food contains soup, the soup may easily spill.

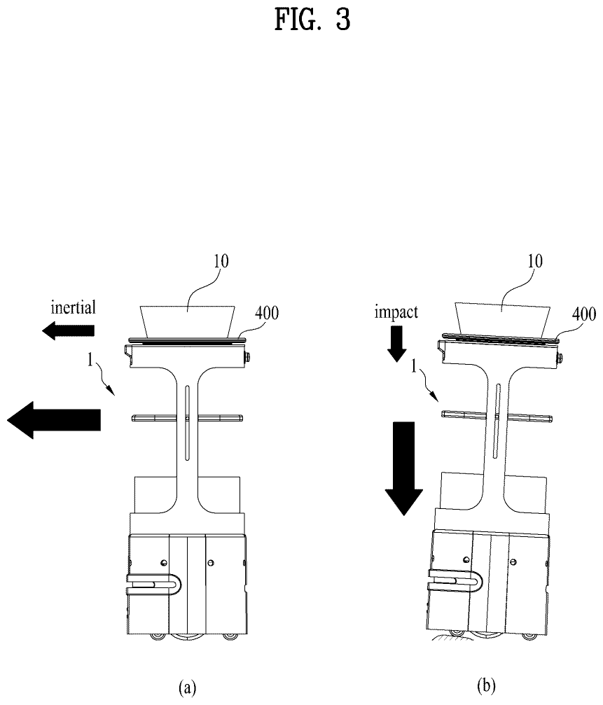

In particular, as shown in (b) in FIG. 3, when there is a step on the ground or a person encounters the robot, the robot may collide with the person or suddenly stop, causing the soup to spill.

In addition to the simple general tray 410 on which the bowl is placed, a shock-absorbing tray module 400 that may absorb shock for safe delivery when food that is prone to spilling such as the soup is contained may be included.

A location of the shock-absorbing tray module 400 is not limited, but it is convenient to move the bowl when the shock-absorbing tray module 400 is located at the top.

Therefore, as shown in FIG. 1, the shock-absorbing tray module 400 may be located at the top of the serving robot 1.

FIG. 3 is a diagram illustrating shock that occurs during traveling of the serving robot 1 according to an embodiment of the present disclosure.

As shown in (a) in FIG. 3, inertia acts in a traveling direction of the serving robot 1, so that when the robot suddenly stops, the soup may spill forward.

When there is the step on the ground as shown in (b) in FIG. 3, the soup in a bowl 10 may spill because of the shock acting in a direction of gravity.

Therefore, the shock-absorbing tray module 400 must have a structure that may absorb both vertical and horizontal shocks to safely transport the bowl 10.

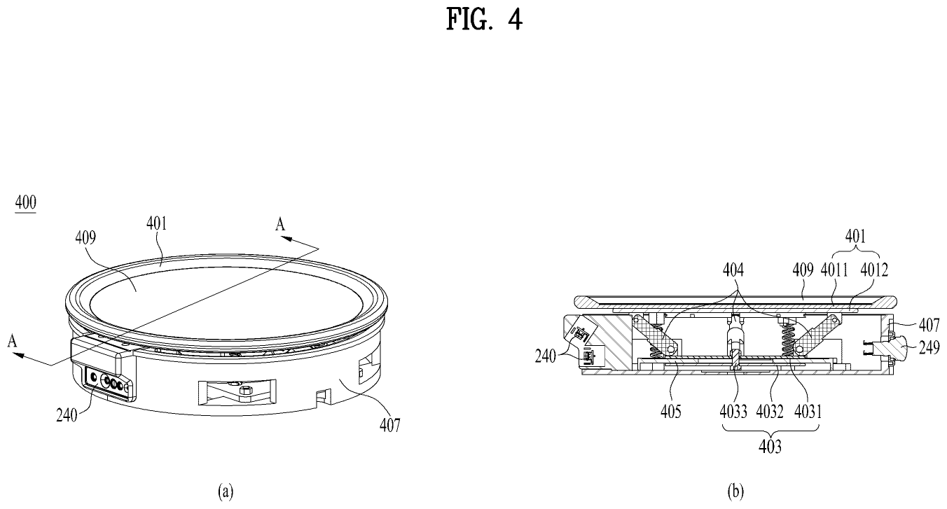

FIG. 4 shows a perspective view and a cross-sectional view of the shock-absorbing tray module 400 according to an embodiment of the present disclosure.

The shock-absorbing tray module 400 may be constructed to be removable from the serving robot 1 and may include the tray housing 407 and a tray plate 401 that is exposed on the tray housing 407 and holds the bowl.

A camera module 240, an emergency braking switch 249, or the like located at the upper portion of the serving robot 1 may be disposed in the housing 407 of the shock-absorbing tray module 400.

The tray plate 401 is shown in a circular shape, but is also able to have a rectangular shape.

A circumference of the tray plate 401 may be bent upwards to prevent the soup from flowing to the floor even when it spills and to prevent the bowl from falling from the shock-absorbing tray module 400.

The tray plate 401 may be composed of two layers: an upper tray 4011 exposed to the outside; and a lower tray 4012 coupled to a lower shock-absorbing structure. The upper tray 4011 and the lower tray 4012 may be coupled to each other using a screw or the like.

An upper portion of the tray plate 401 may further include an anti-slip pad 409. The anti-slip pad 409 may prevent the bowl from moving on the tray plate 401 and may cover the shock-absorbing structure and a fastening portion of the tray plate 401 located at a lower portion of the tray plate 401.

The shock-absorbing structure located inside the housing 407 is roughly composed of a guide plate 403, a damper 404, and a return spring 406.

The guide plate 403 serves to absorb the shock in the horizontal direction and is coupled to a bottom casing 405 fixed to the housing 407 so as to be movable within a predetermined range.

When the serving robot 1 receives the shock in the horizontal direction, the bottom case 405 moves in a direction of shock, and the guide plate 403 changes in location in a direction opposite to the direction of shock with respect to the bottom case 405 because of the inertia.

In other words, in a state in which the serving robot 1 does not move, the guide plate 403 is positioned in place and only the bottom case 405 moves in the direction of shock.

To absorb the shock applied to the serving robot 1 to prevent transmission of the shock to the bowl, the guide plate 403 is coupled to the bottom case 405 so as to be movable in all directions with respect to the bottom case 405.

The damper 404 is a member that serves to absorb a vertical force, has a variable length, and relieves the shock. An air cylinder may be used as the damper 404.

The air cylinder is composed of a cylinder member and a cylindrical member inserted into the cylinder member, and has the same shape as a syringe.

Air within the cylinder member adjusts a speed at which the cylindrical member is inserted into the cylinder member.

When a force is applied to the air cylinder, the cylindrical member compresses air and is inserted into the cylinder member, and a length of the air cylinder is slowly reduced because of air in the cylinder member.

In other words, the damper may alleviate the shock to prevent the shock from being transmitted to the tray plate 401.

The return spring 406 is a member that restores the damper 404 or the guide plate 403 to an original location thereof when the damper 404 or the guide plate 403 moves from the original location thereof. The return spring 406 may be composed of a plurality of spiral springs extending in the vertical direction.

Hereinafter, each component will be described in more detail with reference to the drawings.

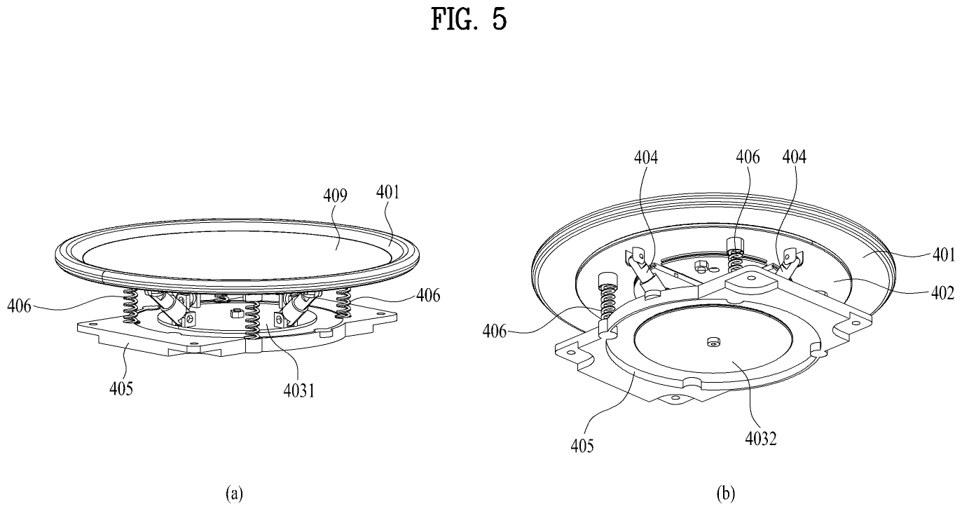

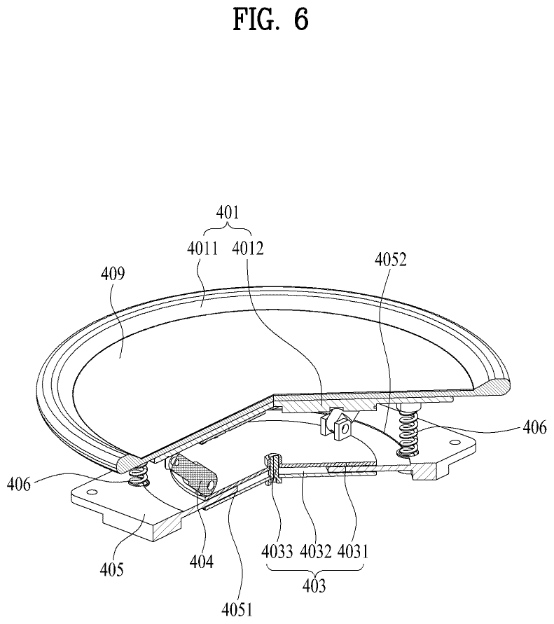

FIG. 5 shows a top perspective view and a bottom perspective view showing a state in which the housing 407 of the shock-absorbing tray module 400 according to an embodiment of the present disclosure is removed, and FIG. 6 is a cross-sectional perspective view showing the shock-absorbing tray module 400 according to an embodiment of the present disclosure.

The shock-absorbing tray module 400 includes the tray plate 401 including a mounting surface on a top surface on which the bowl or the like may be mounted, the bottom casing 405 located under the tray plate 401 and mounted in the tray housing 407, and the guide plate 403 whose location may be changed within a predetermined range.

Additionally, the shock-absorbing tray module 400 includes the damper 404 located between the tray plate 401 and the guide plate 403, and the return spring 406 located between the tray plate 401 and the bottom casing 405.

The guide plate 403 may include an upper guide plate 4031 located on a top surface of the bottom casing 405, a lower guide plate 4032 located on a bottom surface of the bottom casing 405, and a fastening screw 4033 for fastening the upper guide plate 4031 with the lower guide plate 4032.

A shape of the guide plate 403 may not be limited, but the guide plate 403 may be constructed in a circular shape with a symmetrical structure in all directions, as shown in FIG. 5, so as to uniformly buffer the horizontal force.

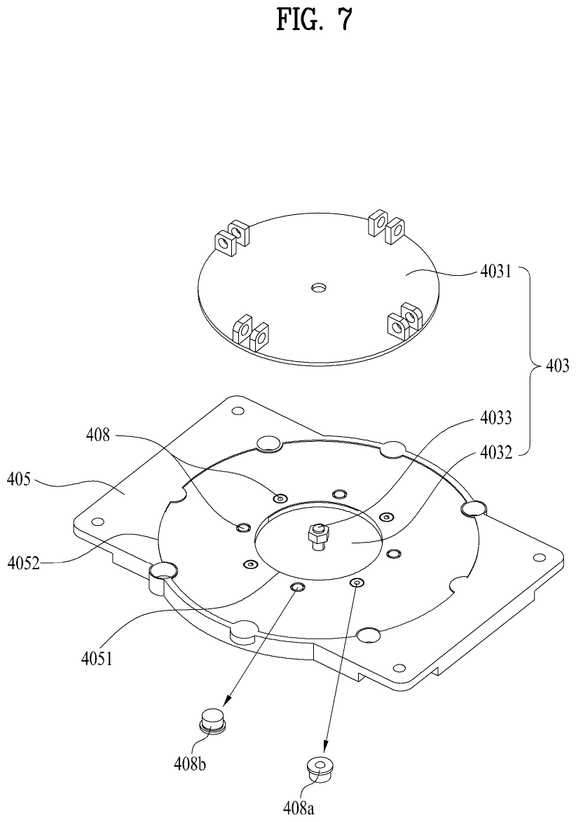

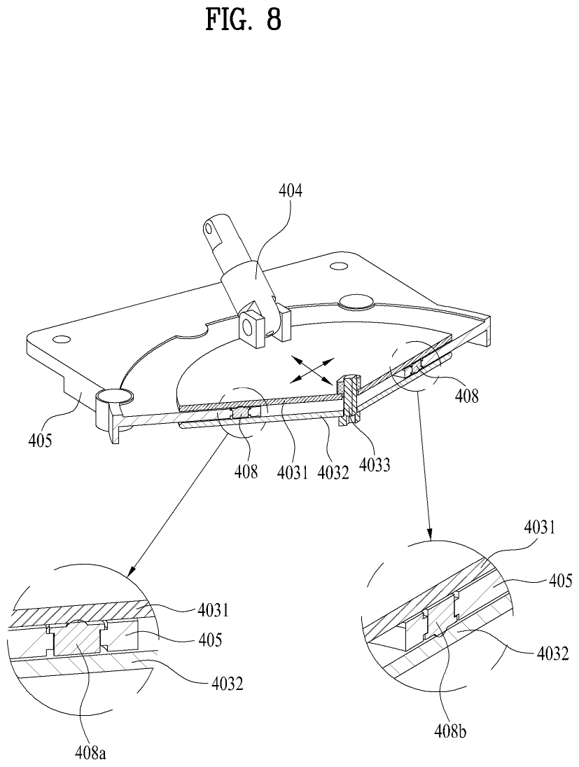

FIG. 7 is an exploded perspective view for illustrating coupling of the bottom casing 405 and the guide plate 403 of the shock-absorbing tray module 400 according to an embodiment of the present disclosure, and FIG. 8 is a cross-sectional view showing a rolling pin 408 of the shock-absorbing tray module 400 according to an embodiment of the present disclosure.

The fastening screw 4033 that fastens the upper guide plate 4031 with the lower guide plate 4032 is fastened through an opening 4051 defined in the bottom casing 405, and a size of the opening 4051 is sufficiently great compared to a diameter of the fastening screw 4033, so that the fastening screw 4033 may change in location within the opening 4051 of the bottom casing 405.

As shown in FIG. 7, a plurality of rolling pins 408 located around the opening 4051 may be included.

The rolling pin 408 may include a sphere partially exposed to the outside of a pin housing, and an exposed surface of the sphere may vary as the sphere moves within the pin housing. That is, the pin housing of the rolling pin 408 may be coupled to the bottom casing 405, and the sphere may protrude in a direction of the top or bottom surface of the bottom casing 405 and be in contact with the guide plate 403.

As the location of the guide plate 403 changes on the bottom casing 405, the guide plate 403 may move while the sphere of the rolling pin 408 rotates and minimizes friction. Because the guide plate 403 includes the upper guide plate 4031 and the lower guide plate 4032 located on the top surface of the bottom casing 405, the rolling pin 408 may also include a first rolling pin 408a protruding upwards and a second rolling pin 408b protruding downwards.

As shown in FIG. 8, the rolling pin 408 may be inserted into a hole defined around the opening 4051 of the bottom casing 405, and may be divided into the first rolling pin 408a and the second rolling pin 408b based on an insertion direction.

The rolling pin 408 may be located around the opening 4051 of the bottom casing 405 and may remain in contact with the guide plate 403 even when the location of the guide plate 403 changes. The plurality of rolling pins 408 may be arranged at an equal spacing around the opening 4051, and the first rolling pins 408a and the second rolling pins 408b may be arranged alternately.

When the guide plate 403 touches a circumference of the opening 4051, the guide plate 403 is not able to move further as the range of movement is limited. Additionally, a stop step 4052 may be formed at a periphery of the bottom casing 405 to limit the range of movement of the guide plate 403.

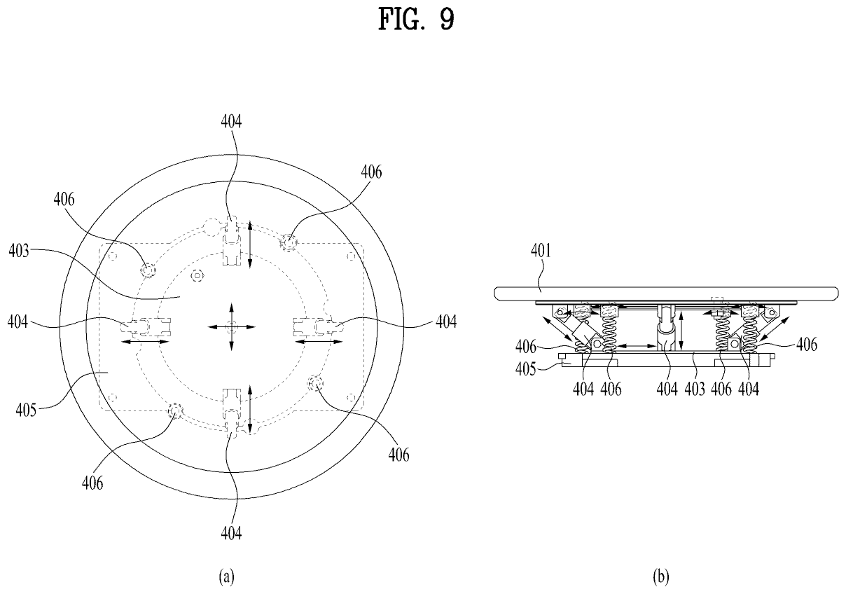

FIG. 9 shows a plan view and a side view showing the damper 404 and the return spring 406 of the shock-absorbing tray module 400 according to an embodiment of the present disclosure.

As shown in (a) in FIG. 9, a plurality of dampers 404 in the present disclosure are arranged at an equal spacing along a circumference of the guide plate 403, and in the present embodiment, four dampers 404 are coupled onto the guide plate at a 90° spacing.

The return springs 406 may be arranged at an equal spacing like the dampers 404 and may be disposed between a pair of dampers 404. The dampers 404 and the return springs 406 are arranged so as not to interfere with each other.

As shown in (b) in FIG. 9, a lower end of the damper 404 is coupled in a hinge manner 404b to the guide plate 403 and an upper end thereof is coupled in a hinge manner 404a to the tray plate 401. When the length of the damper 404 changes, at least one of an angle thereof with the guide plate 403 or an angle thereof with the tray plate 401 may change.

To secure the range of movement of the guide plate 403, because the guide plate 403 is smaller than the bottom casing 405, the damper 404 is disposed to be inclined at a predetermined angle.

That is, the four dampers 404 may extend in different directions from the guide plate 403 and may operate in response to forces in the different directions.

As shown in (b) in FIG. 9, the return spring 406 connects the upper tray plate 401 at the top with the lower bottom casing 405 at the bottom and is disposed in the vertical direction. The return spring 406 provides a force to restore the tray plate 401 and the bottom casing 405 to original locations thereof when they are misaligned.

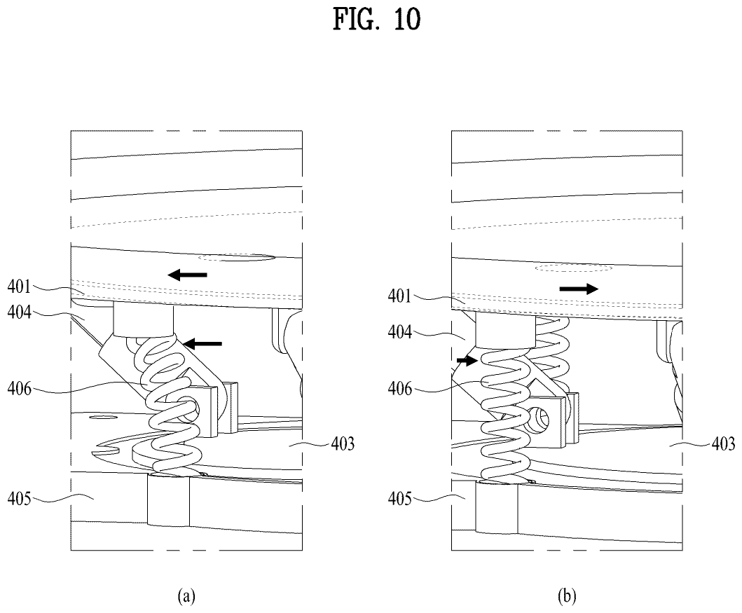

FIG. 10 is a diagram for illustrating an operation of the return spring 406 of the shock-absorbing tray module 400 according to an embodiment of the present disclosure.

When the serving robot 1 suddenly stops or sharply turns, the lower bottom casing 405 moves with the serving robot, but the guide plate 403 moves on the bottom casing 405 because of the inertia in an opposite direction to a moving direction of the serving robot 1. When viewed from the outside, the bottom casing 405 moves and the guide plate 403 remains in place.

The tray plate 401, which is connected to the guide plate 403 via the damper 404, also does not directly follow the moving direction of the serving robot 1 like the guide plate 403, but moves in an original direction resulted from the inertia or remains in place.

In this regard, the return spring 406 is bent because the tray plate 401 and the bottom casing 405 are misaligned, as shown in (a) in FIG. 10, and provides a force to restore an original state as shown in (b) by elasticity.

In this regard, when the original state is restored quickly by the return spring 406, the food placed on the tray plate 401 may spill, so that the damper 404 adjusts a speed of movement of the tray plate 401 by the return spring 406.

As the tray plate 401 moves by a restoring force of the return spring 406 and the damper 404 increases in length and then is restored to have an original length thereof, the guide plate 403 may also be restored to an original location thereof on the bottom casing 405.

In other words, with respect to an acceleration direction of the serving robot 1, the bottom casing 405 moves first and then the return spring 406 moves the tray plate 401. As the damper 404 changes the length thereof, the tray plate 401 reduces the movement speed thereof, and as the damper 404 is restored to have the original length thereof, the guide plate 403 is also moved.

When moving over the bump on the floor, as the serving robot 1 tilts, tray plate 401 may also tilt. In this regard, as the length of the damper 404 changes, the tilting of the tray plate 401 may be minimized.

At this time, angles of the hinges 404a and 404b at both ends of the damper 404 change. When the serving robot 1 completely crosses the bump and is disposed in the vertical direction, the angle between the damper 404 and the tray plate 401 may return to an original state thereof. The damper 404 may minimize the tilting of the tray plate 401 while changing the length and the angle thereof.

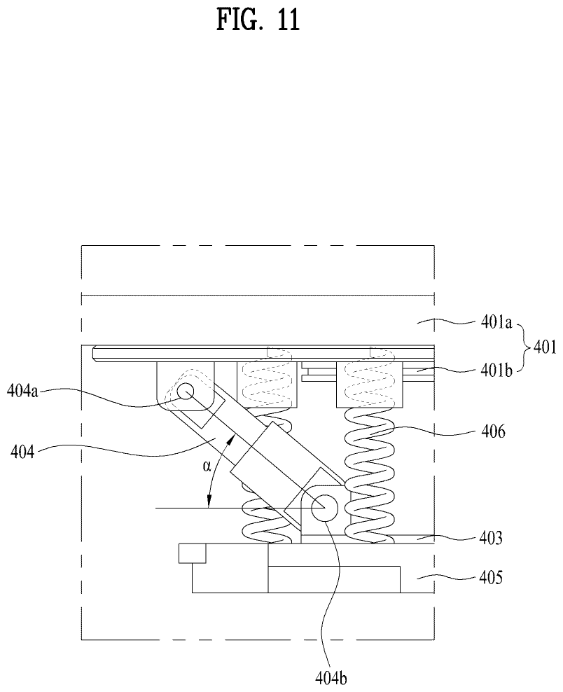

FIG. 11 is a partial side view for illustrating an arrangement of the damper 404 of the shock-absorbing tray module 400 according to an embodiment of the present disclosure. The damper 404 may be disposed such that an angle α with the guide plate 403 is equal to or greater than 40° and equal to or smaller than 45°.

When the angle exceeds 45°, the damper 404 may not be compressed and the shock may be transmitted, and when the angle is set to an angle smaller than 40°, there is a problem that an amount of vertical movement of the tray plate 401 is reduced compared to the change in the length of the damper 404.

Therefore, when the angle of the damper 404 is set to be equal to or greater than 40° and equal to or smaller than 45°, a moving stroke is maximized and an applied force is minimized, thereby maximizing the effect of shock-absorbing.

In this regard, a vertical compression amount of the return spring 406 may be smaller than that of the damper 404 to reduce an influence of the return spring 406 on a compression force of the damper 404.

As described above, according to the embodiment of the present disclosure, the guide plate 403 may move on the bottom casing 405, and the plurality of dampers 404 may absorb the shock by reducing an instantaneous acceleration of the serving robot, thereby minimizing the overflow of the liquid food in the bowl.

Additionally, the tray is able to be easily replaced, and the shock-absorbing tray module itself is not an electronic product, so that there is no risk of breakdown even with inflow of water.

Because of the damper 404 disposed at an angle, forces in the vertical and lateral directions may be buffered, thereby minimizing shaking resulted from the acceleration in addition to shaking resulted from the bump.

Additionally, the shock-absorbing tray module 400 is replaceable in the serving robot 1, making maintenance easy.

It will be apparent to those skilled in the art that the present disclosure may be embodied in other specific forms without departing from the spirit and essential characteristics of the disclosure. Thus, the above embodiments are to be considered in all respects as illustrative and not restrictive. The scope of the disclosure should be determined by reasonable interpretation of the appended claims and all change which comes within the equivalent scope of the disclosure are included in the scope of the disclosure.

1-20. (canceled)

21. A shock-absorbing tray module comprising:
a tray plate;
a bottom casing located under the tray plate;
a guide plate coupled to the bottom casing, the guide plate being configured to be movable within a predetermined range along the bottom casing;
at least one damper connecting the tray plate to the guide plate, the at least one damper being configured to vary in length depending on a movement of the tray plate; and
at least one return spring connecting the tray plate to the bottom casing.

22. The shock-absorbing tray module of claim 21, wherein the at least one damper includes a plurality of dampers spaced apart from each other at an equal spacing along a circumference of the tray plate.

23. The shock-absorbing tray module of claim 22, wherein the at least one return spring includes a plurality of return springs spaced apart from each other at an equal spacing along the circumference of the tray plate, each return spring being located between adjacent dampers of the plurality of dampers.

24. The shock-absorbing tray module of claim 21, wherein the at least one damper is pivotally coupled to the guide plate and the tray plate.

25. The shock-absorbing tray module of claim 24, wherein, when viewed in a plan view, a size of the guide plate is smaller than a size of the tray plate, and
wherein the at least one damper extends at an angle upward from the guide plate.

26. The shock-absorbing tray module of claim 25, wherein the angle of the at least one damper is 40° to 45°.

27. The shock-absorbing tray module of claim 21, wherein the at least one return spring extends in a vertical direction, and
wherein a vertical buffering force of the at least one return spring is smaller than a buffering force of the at least one damper.

28. The shock-absorbing tray module of claim 21, further comprising at least one rolling pin protruding from the bottom casing, the at least one rolling pin contacting the guide plate.

29. The shock-absorbing tray module of claim 28, wherein the bottom casing includes an opening, and
wherein the guide plate includes:
an upper guide plate located above the bottom casing;
a lower guide plate located below the bottom casing; and
a fastener fastening the upper guide plate to the lower guide plate, the fastener being located in the opening of the bottom casing.

30. The shock-absorbing tray module of claim 29, wherein a diameter of the opening of the bottom casing is greater than a diameter of the fastener.

31. The shock-absorbing tray module of claim 29, wherein the at least one rolling pin includes:
at least one first guide pin facing the upper guide plate; and
at least one second guide pin facing the lower guide plate.

32. The shock-absorbing tray module of claim 31, wherein the at least one first guide pin includes a plurality of first guide pins located along the opening in the bottom casing, and
wherein the at least one second guide pin includes a plurality of second guide pins located along the opening in the bottom casing such that the first guide pins and the second guide pins are alternately arranged along the opening of the bottom casing.

33. The shock-absorbing tray module of claim 28, wherein the bottom casing further includes a stop step at a periphery of the guide plate to limit the movement of the guide plate.

34. The shock-absorbing tray module of claim 21, wherein the at least one damper includes an air cylinder.

35. A serving robot comprising:
a driver configured to move the serving robot;
a body located on the driver; and
a shock-absorbing tray module located in the body, the shock-absorbing tray module including:
a tray plate;
a bottom casing located under the tray plate;
a guide plate coupled to the bottom casing, the guide plate being configured to be movable within a predetermined range along the bottom casing;
at least one damper connecting the tray plate to the guide plate, the at least one damper being configured to vary in length depending on a movement of the tray plate; and
at least one return spring connecting the tray plate to the bottom casing.

36. The serving robot of claim 35, wherein, when viewed in a plan view, a size of the guide plate is smaller than a size of the tray plate, and
wherein the at least one damper extends at an angle of 40° to 45° with respect to the guide plate.

37. The serving robot of claim 35, wherein the at least one return spring extends in a vertical direction, and
wherein a vertical buffering force of the at least one return spring is smaller than a buffering force of the at least one damper.

38. The serving robot of claim 35, further comprising at least one rolling pin protruding from the bottom casing, the at least one rolling pin contacting the guide plate.

39. The serving robot of claim 38, wherein the bottom casing includes an opening, and
wherein the guide plate includes:
an upper guide plate located above the bottom casing;
a lower guide plate located below the bottom casing; and
a fastener fastening the upper guide plate to the lower guide plate, the fastener being located in the opening of the bottom casing.

40. The serving robot of claim 35, wherein the shock-absorbing tray module is located at an upper portion of the body, and
wherein the serving robot further comprises at least one of a tray and a collection basket located under the shock-absorbing tray module.
